(19) United States
(12) Patent Application Publication
(10) Pub. No.: US 2008/0012354 A1
(43) Pub. Date: Jan. 17, 2008

(54) Latch control by gear position sensing

(76) Inventor: John Phillip Chevalier, London (GB)

Correspondence Address: DICKSTEIN SHAPIRO LLP, 1825 EYE STREET NW, Washington, DC, 20006-5403, US

(21) Appl. No.: 11/441,212

(22) Filed: May 26, 2006

(51) Int. Cl. E05C 3/06

(52) U.S. Cl. 292/216

(57) ABSTRACT

A latch assembly control method and, wherein a latch assembly is integrated with a motor having at least one gear thereof for actuating a plurality of components of the latch assembly. A geartooth sensor can be associated with the latch assembly, wherein the geartooth sensor senses a position of one or more gears, wherein the gear completes less than one revolution to thereby provide a known reference point registration and calibration of the latch assembly via data collected from the geartooth sensor.

### TECHNICAL FIELD

Embodiments are generally related to door latch assemblies, including door latching mechanisms utilized in automobiles and other vehicles. Embodiments are also related to geartooth sensor devices and techniques thereof.

### BACKGROUND OF THE INVENTION

Latching mechanisms are utilized in a variety of commercial and industrial applications, such as automobiles, airplanes, trucks, and the like. For example, an automotive closure, such as a door for an automobile passenger compartment, is typically hinged to swing between open and closed positions and conventionally includes a door latch that is housed between inner and outer panels of the door. The door latch functions in a well-known manner to latch the door when it is closed and to lock the door in the closed position or to unlock and unlatch the door so that the door can be opened manually.

The door latch can be operated remotely from inside the passenger compartment by two distinct operators—a sill button or electric switch that controls the locking function and a handle that controls the latching function. The door latch is also operated remotely from the exterior of the automobile by a handle or push button that controls the latching function. A second distinct exterior operator, such as a key lock cylinder, may also be provided to control the locking function, particularly in the case of a front vehicle door. Each operator is accessible outside the door structure and extends into the door structure where it is operatively connected to the door latch mechanism by a cable actuator assembly or linkage system located inside the door structure.

Vehicles, such as passenger cars, are therefore commonly equipped with individual door latch assemblies which secure respective passenger and driver side doors to the vehicle. Each door latch assembly is typically provided with manual release mechanisms or lever for unlatching the door latch from the inside and outside of the vehicle, e.g. respective inner and outer door handles. In addition, many vehicles also include an electrically controlled actuator for remotely locking and unlocking the door latches.

One of the problems inherent with conventional latching mechanisms is that it is difficult, but necessary, to control motors, including gears thereof, within vehicle latch assemblies. In particular, it is desirable to enable all required functions of a vehicle latch assembly utilizing only a single motor, because of the efficiencies that can result from such a configuration. Current solutions employ a complex ring magnet, together with a sensor that acts upon a gear with multiple revolutions. A need thus exists for a method and system which overcomes and simplifies the need for multiple gear revolutions, including the current complex ring magnet.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved latch mechanism.

It is another aspect of the present invention to provide for improved latching methods and systems for use in automobiles and other vehicles.

It is yet a further aspect of the present invention to provide for a geartooth sensor that provides data for the control of a vehicle door latch assembly.

The aforementioned aspects of the invention and other objectives and advantages can now be achieved as described herein. A latch assembly control method and system are disclosed herein, wherein a latch assembly is integrated with a motor having at least one gear thereof for actuating a plurality of components of the latch assembly. A geartooth sensor can be associated with the latch assembly, wherein the geartooth sensor senses a position of one or more gears, wherein the gear completes less than one revolution to thereby provide a known reference point registration and calibration of the latch assembly via data collected from the geartooth sensor.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle door mounted to a passenger vehicle in which a preferred embodiment of the present invention can be implemented;

FIG. 2 illustrates a perspective view a sensor associated with a gear having a plurality of teeth, which may be adapted for use in accordance with an embodiment of the present invention;

FIG. 3 illustrates a top view of a sensor with a rotatable member having a plurality of teeth, which may be adapted for use in accordance with an embodiment of the present invention;

FIG. 4 illustrates a side view of the configuration depicted in FIG. 3;

FIG. 5 illustrates a time-based waveform representative of the algebraic sum of signals provided by the sensor depicted in FIGS. 2-4;

FIG. 6 illustrates a time-based fourth output signal provided by comparing the magnitude of the waveform in FIG. 5 to a reference value; and

FIG. 7 illustrates a high-level block diagram of a system, which can be implemented in accordance with a preferred embodiment of the present invention; and

FIG. 8 illustrates a high-level block diagram of a system, which can be implemented in accordance with an alternative embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

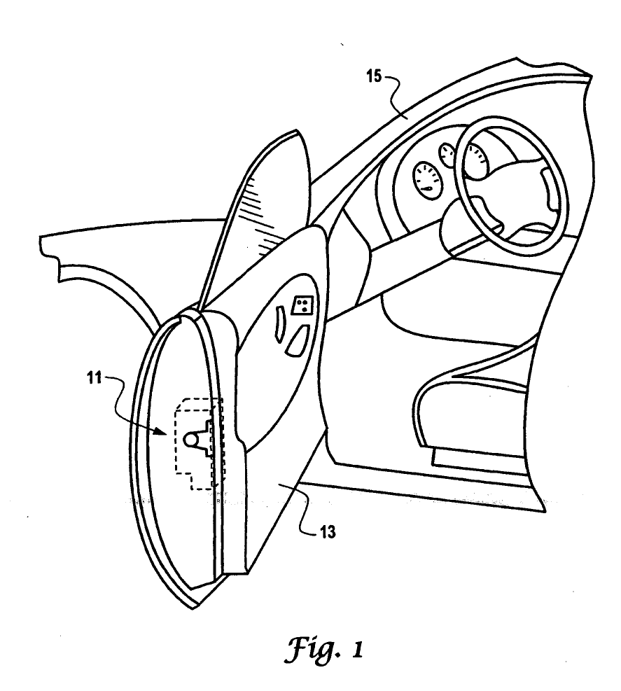

FIG. 1 illustrates a perspective view of a vehicle door 13 mounted to a passenger vehicle in which a preferred embodiment of the present invention can be implemented. A vehicle, such as an automobile can be equipped with one or more individual door latch assemblies 11, which secure respective passenger and driver side doors to the vehicle 15. Each door latch assembly 11 is typically provided with manual release mechanisms or lever for unlatching the door latch from the inside and outside of the vehicle, e.g. respective inner and outer door handles. In addition, many vehicles can also be equipped with electrically controlled actuators for remotely locking and unlocking the door latches. As indicated in FIG. 1, a door latch assembly 11 can be mounted to a driver's side vehicle door 13 of a passenger vehicle 15. The door latch assembly 11 may be mounted to front and rear passenger side doors thereof and may be incorporated into a sliding side door, rear door, a rear hatch or a lift gate thereof, depending upon design constraints.

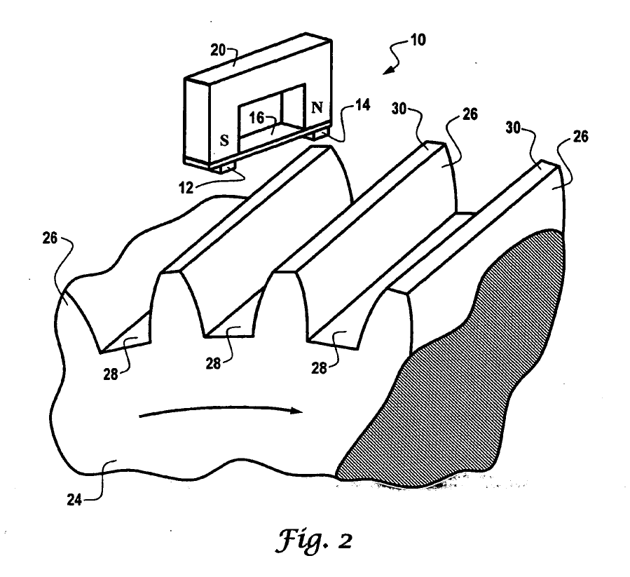

FIG. 2 illustrates a perspective view of a sensor 10 associated with a rotatable member, such as a gear, which has a plurality of discontinuities, such as teeth, formed in its peripheral surface. Sensor 10 can be adapted for use in accordance with an embodiment of the present invention. Sensor 10 is not considered a limiting feature of the present invention but is describe herein for general illustrative and edification purposes only. It can be appreciated that other types of sensors can be implemented in place of sensor 10.

In general, sensor 10 comprises a first magnetically sensitive device 12 and a second magnetically sensitive device 14. In a preferred embodiment of the present invention, the first and second magnetically sensitive devices can be Hall-effect transducers. In FIG. 2, the first and second magnetically sensitive devices are disposed on a ceramic substrate 16, which can also support an electronic circuit to amplify first and second output signals that are provided by the first and second magnetically sensitive devices, respectively. In addition, certain embodiments of the present invention can also combine the first and second output signals and compare the combined signal to a reference magnitude.

With continued reference to FIG. 2, a magnet 20 can provide a means for disposing the first magnetically sensitive device 12 in a magnetic field of a first direction and for disposing the second magnetically sensitive device 14 in a magnetic field of a second direction. As shown in FIG. 2, the U-shaped magnet 20 generally provides such a disposing means because its south pole is proximate the first magnetically sensitive device 12 and its north pole is proximate the second magnetically sensitive device 14.

The sensor 10 can be disposed proximate a rotatable member 24 which has at least one discontinuity in its surface. If the rotatable member 24 is a gear, as shown in FIG. 2, a plurality of teeth 26 extend from the outer periphery of the rotatable member 24. Between each tooth is a space 28. The sensor 10 can be disposed proximate the rotatable member 24 in such a manner that its first and second magnetically sensitive devices are simultaneously located proximate different regions of its outer periphery. In other words, when the first magnetically sensitive device 12 is proximate a tooth 26, the second magnetically sensitive device 14 is proximate a space 28. To achieve this result, the axis of the sensor 10 can be disposed at an angle relative to the axis of the rotatable member 24. Rotatable member 24 can be implemented, for example, as a gear having a plurality of teeth 26 integrated therewith.

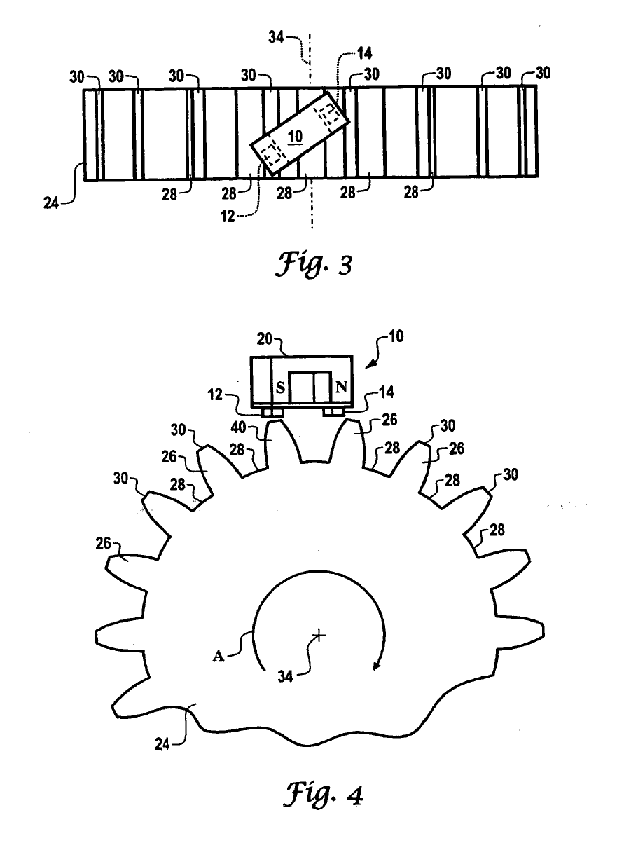

FIGS. 3 and 4 illustrate the relative position of the sensor 10 and the rotatable member 24. In FIG. 3, the outer surface 30 at the distal end of each tooth is identified and the bottom surface of each space 28 is identified. As can be seen in FIG. 3, the first magnetically sensitive device 12 is disposed proximate an upper tooth surface 30 while the second magnetically sensitive device 14 is disposed proximate a space 28. As the rotatable member 24 rotates about its central axis 34, each of the two magnetically sensitive devices will sequentially experience both teeth and interstitial spaces. However, the spacing between the first and second magnetically sensitive devices, the spacing between the teeth of the rotatable member and the relative angle between the sensor 10 and the angle of rotation 34 assure that the first and second magnetically sensitive devices are always disposed proximate different regions of the rotatable member 24.

FIG. 4 illustrates a side view of the configuration depicted in FIG. 3. As the rotatable member 24 rotates about its central axis 34, as indicated by arrow A, the first and second magnetically sensitive devices are sequentially disposed proximate the discontinuities, or teeth, of the rotatable member. The first magnetically sensitive device 12 has an output signal which is representative of the magnitude and direction of the magnetic field in which is disposed. Similarly, the second magnetically sensitive device 14 also has an output signal which is representative of the strength and direction of the magnetic field in which it is disposed.

With reference to FIG. 4, it can be seen that the magnetic field provided by magnet 20 proximate the first magnetically sensitive device 12 is effected by the proximity of tooth 40, whereas the magnetic field provided by the north pole of magnet 20 and in which the second magnetically sensitive device 14 is disposed is not affected by the direct proximity of a tooth 26. Therefore, the first and second output signals provided by the first and second magnetically sensitive devices will be different from each other because of the different strengths and directions of the magnetic fields in which they are disposed.

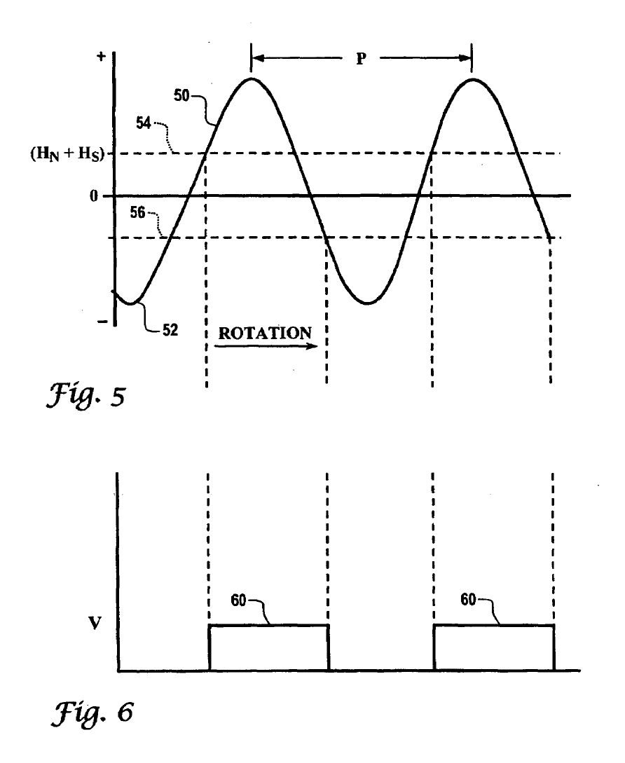

If the first output signal provided by the first magnetically sensitive device 12 is identified as Hs because of its proximity to the south pole of magnet 20 and the second output of the second magnetically sensitive device 14 as identified as HN because of its proximity to the north pole of magnet 20, the algebraic sum of these two signals can be represented by the waveform shown in FIG. 5. As the rotatable member 24 is rotated about its centerline 34, the algebraic sum of the first and second output signals will represent a generally sinusoidal waveform such as that identified by reference numeral 50 in FIG. 5.

It should be understood that the precise shape of the waveform 50 is a function of the shape and configuration of the teeth of the rotatable member. The distance P between peaks of the waveform 50 represents the arcuate distance between adjacent teeth. When the first magnetically sensitive device 12 is disposed proximate a face 30 of a geartooth 26, the algebraic sum of the first and second output signals reaches a maximum which can be negative or positive, depending on the position of the magnetically sensitive device relative to the magnet 20. For example, negative peak 52 of waveform 50 would be representative of the disposition of the first magnetically sensitive device 12 directly over the outer surface 30 while the second magnetically sensitive device 14 is disposed directly over a space 28.

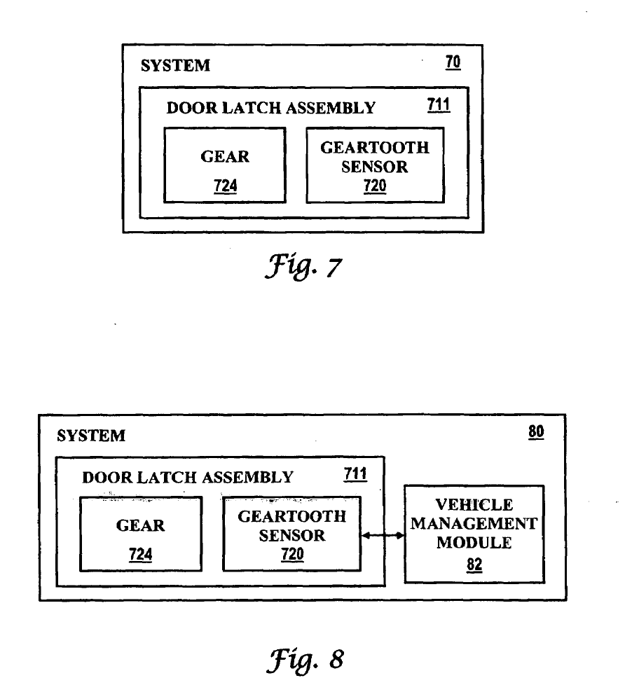

FIG. 7 illustrates a system, which can be implemented in accordance with a preferred embodiment of the present invention.

It should be apparent that alternative dimensions between the first and second magnetically sensitive devices can be applied in alternative embodiments of the present invention. In addition, the relative angle of disposition between the sensor of the present invention and the central axis of rotation of the rotatable member can be varied. The effect on the waveform 50 by these alternative positions can significantly change the maximum and minimum values of the waveform and, in some cases, may change the general sinusoidal shape of the waveform or invert its peaks. However, these alternative embodiments should be considered to be within the scope of the embodiments disclosed herein.

If an electronic circuit associated with the present invention is provided with means for comparing the magnitude of waveform 50 to reference values, the circuit can provide additional information relative to the position of the teeth in comparison to the position of the first and second magnetically sensitive devices. For example, if a first reference magnitude 54 and a second reference magnitude 56 are compared to the magnitude of the waveform 50 a third output signal can be provided.

FIG. 6 shows the third output signal which is a square wave that is switched to a high output when the waveform 50 exceeds a first reference value 54 and switched low when the waveform 50 exceeds a second reference value 56. It should be apparent that the second reference value 56 shown in FIG. 5 is a negative value and that waveform 50 exceeds that second reference value 56 when its value becomes more negative than the reference value.

A logic circuit can examine the results of the output pulses 60 of the third output signal and determine the position of the teeth relative to the sensor. For example, the presence of a high signal pulse 60 is representative of the presence of a tooth proximate the second magnetically device which, in turn, is disposed proximate the north pole of magnet 20. By inverting the positions of the magnetically sensitive devices relative to the magnet, the waveform 50 can be inverted.

FIG. 7 illustrates a high-level block diagram of a system 70, which can be implemented in accordance with a preferred embodiment of the present invention. System 70 generally includes a door latch assembly 711, which is analogous to the door latch assembly 11 of FIG. 1. Door latch assembly 711 also can be configured to include a gear 724, which may be, for example, a gear associated with a motor that actuates one or more components of the door latch assembly 711. System 70 also includes a geartooth sensor 720, which is also integrated with the door latch assembly 711. Geartooth sensor 720 is generally analogous to the sensor 20 depicted in FIGS. 1-4 herein. It can be appreciated, however, that geartooth sensor 720 can be implemented as one of many possible geartooth sensors.

One example of a geartooth sensor, which can be adapted for use in accordance with an embodiment of the present invention is disclosed in U.S. Pat. No. 5,304,926, “Geartooth Position Sensor with Two Hall Effect Elements,” which was issued to M. T. Wu on Apr. 19, 1994. Another example of a geartooth sensor, which can be adapted for use in accordance with an alternative embodiment of the present invention is disclosed in U.S. Pat. No. 6,404,188, “Single Geartooth Sensor Yielding Multiple Output Pulse Trains,” which issued to Lamar Ricks on Jun. 11, 2002. A further example of a geartooth sensor, which can be adapted for use in accordance with an alternative embodiment of the present invention is disclosed in U.S. Pat. No. 6,172,500, “Target Design for Geartooth Sensor with Minimal Number of Unique Segments Combined in Nonrepeating Fashion,” which issued to Robert Bicking on Jan. 9, 2001. U.S. Pat. Nos. 5,304,926, 6,404,188, and 6,172,500 are incorporated herein by reference.

FIG. 8 illustrates a system 80, which can be implemented in accordance with an alternative embodiment of the present invention. Note that in FIGS. 7 and 8, identical or similar parts are generally indicated by identical reference numeral. Thus, system 80 also includes door latch assembly 711, including one or more gears 724 and one or more gears 720. System 80 also includes a vehicle management module 82, which can communicate with geartooth sensor 720. Vehicle management module 82 provides a number of features. For example, vehicle management module 82 can communicate with the door latch assembly 711 for the control of the vehicle door latch assembly, including the motor and gears thereof. Additionally, vehicle management module 82 can calibrate one or more components of the door latch assembly based on data collected from the geartooth sensor.

Note that the term “module” can refer to a collection of routines and data structures that perform a particular task, a collection of tasks, and/or implements a particular abstract data type. Modules of this type can also be referred to as software modules and usually include a interface, which lists the constants, data types, variables, and routines that can be accessed by other modules or routines, and an implementation, which is private and only accessible to the module, and which contains the source code that actually implements the routines in the module.

Thus, a module can comprise an individual module or a group of modules (routines, subroutines, etc.) to form a single module. Vehicle management module 82 can therefore be implemented as a software module or a group of such modules which are stored within a memory location, preferably within a computer integrated with a vehicle, such as an automobile. Such a module can be retrieved from memory and processed via one or more microprocessors associated with the computer and/or vehicle.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

What is claimed is:

1. A latch assembly control method, comprising the steps of:
integrating a latch assembly with a motor having at least one gear thereof for actuating a plurality of components of said latch assembly wherein each one of said at least one gear has a multiplicity of gearteeth; and
associating a geartooth sensor with said latch assembly, wherein said geartooth sensor senses a position of said at least one of said gearteeth, and wherein said at least one gear completes less than one revolution.

2. The method of claim 1 further comprising the step of configuring said geartooth sensor to comprise at least one magnet located proximate to said at least one gear of said motor.

3. The method of claim 1 further comprising the step of providing the latch assembly in a vehicle door.

4. The method of claim 1 further comprising the step of integrating said geartooth sensor with said latch assembly.

5. The method of claim 1 further comprising the step of providing a vehicle management module which communicates with said door latch assembly for control of said vehicle door latch assembly, including said motor and said at least one gear thereof.

6. The method of claim 5 further comprising the step of communicating data from said geartooth sensor, wherein said data is indicative of a known reference point associated with said at least one gear.

7. The method of claim 6 further comprising the step of controlling, via said vehicle management module, at least one component of said door latch assembly based on the data.

8. The method of claim 1 further comprising the step of providing a plurality of geartooth sensors for collecting position data associated with said at least one gear.

9. The method of claim 6 further comprising the step of actuating at least one component of said door latch assembly utilizing said vehicle management module based on data collected from said plurality of geartooth sensors.

10. The method of claim 6 further comprising the step of actuating at least one component of said door latch assembly utilizing said vehicle management module based on data collected from said at least one geartooth sensor.

11. A latch assembly control system, comprising:
a latch assembly integrated with a motor having at least one gear thereof for actuating a plurality of components of said latch assembly; and
a geartooth sensor associated with said latch assembly, wherein said geartooth sensor senses the movement of at least one of said gearteeth to thereby sense a position of said at least one gear, and wherein said at least one gear completes less than one revolution.

12. The system of claim 11 wherein said geartooth sensor comprises at least one magnet located proximate to said at least one gear of said motor.

13. The system of claim 11 wherein said latch assembly is a vehicle door latch assembly.

14. The system of claim 11 wherein said geartooth sensor is integrated with said latch assembly.

15. The system of claim 11 further comprising a vehicle management module which communicates with said door latch assembly for control of said vehicle door latch assembly, including said motor and said at least one gear thereof.

16. The system of claim 15 wherein said geartooth sensor communicates data indicative of a known reference point associated with said at least one gear.

17. The system of claim 16 wherein said vehicle management module controls at least one component of said door latch assembly based on the data.

18. The system of claim 11 further comprising a plurality of geartooth sensors for collecting position data associated with said at least one gear.

19. The system of claim 15 wherein said vehicle management module actuates at least one component of said door latch assembly based on data collected from said plurality of geartooth sensor.

20. A latch assembly control system, comprising:
a latch assembly integrated with a motor having at least one gear thereof for actuating a plurality of components of said latch assembly, wherein each one of said at least one gear has a multiplicity of gearteeth; and
a geartooth sensor associated with said latch assembly, wherein said geartooth sensor senses the movement of at least one of said gearteeth to thereby sense a position of said at least one gear, and wherein said at least one gear completes less than one revolution to thereby provide a known reference point registration via at least one signal generated by said geartooth sensor; and
a vehicle management module which communicates with said door latch assembly for control of said vehicle door latch assembly, including said motor and said at least one gear thereof, wherein said vehicle management module actuates at least one component of said door latch assembly based on at least one signal generated by said at least one geartooth sensor.
